(19) United States
(12) Patent Application Publication
(10) Pub. No.: US 2026/0024186 A1
(43) Pub. Date: Jan. 22, 2026

(54) METHODS AND SYSTEMS ENABLING DETERMINATION OF A DEPTH PROFILE OF A SEMICONDUCTOR SPECIMEN

(71) Applicant: Applied Materials Israel Ltd., Rehovot (IL)

(72) Inventors: Vadim KUCHIK, Kiriat Ekron (IL); Itay ASSULIN, Rehovot (IL); Boris LEVANT, Rehovot (IL); Ran YACOBY, Jerusalem (IL); Ran ITAY, Rishon Lezion (IL)

(21) Appl. No.: 18/780,415

(22) Filed: Jul. 22, 2024

(51) Int. Cl. G06T 7/00; G06T 7/50

(52) U.S. Cl. CPC G06T 7/0004; G06T 7/50; G06T 2207/20081; G06T 2207/30148

(57) ABSTRACT

There are provided systems and methods comprising obtaining data D_{pixel_intensity} informative of a pixel intensity profile of a given specimen, feeding the data D_{pixel_intensity} to a machine learning model to determine, based on the data D_{pixel_intensity}, data informative of a depth of the given specimen, wherein the machine learning model has been trained with a training set, wherein at least part of the training set has been generated based on a model operative to predict, based on one or more parameters informative of a specimen, data informative of a pixel intensity profile of the specimen.

### TECHNICAL FIELD

The presently disclosed subject matter relates, in general, to the field of examination of a specimen, and more specifically, to automating the examination of a specimen.

### BACKGROUND

Current demands for high density and performance associated with ultra large-scale integration of fabricated devices require submicron features, increased transistor and circuit speeds, and improved reliability. Such demands require formation of device features with high precision and uniformity, which, in turn, necessitates careful monitoring of the fabrication process, including automated examination of the devices while they are still in the form of semiconductor wafers.

Examination processes are used at various steps during semiconductor fabrication to measure dimensions of the specimens (metrology), and/or to detect manufacturing errors and/or to classify defects on specimens (e.g., Automatic Defect Classification (ADC), Automatic Defect Review (ADR), etc.).

### GENERAL DESCRIPTION

In accordance with certain aspects of the presently disclosed subject matter, there is provided a system comprising one or more processing circuitries configured to obtain data D_{pixel_intensity} informative of a pixel intensity profile of a given specimen, and feed the data D_{pixel_intensity} to a machine learning model to determine, based on the data D_{pixel_intensity}, data informative of a depth of the given specimen, wherein the machine learning model has been trained with a training set, wherein at least part of the training set has been generated based on a model operative to simulate, based on one or more parameters informative of a specimen, data informative of a pixel intensity profile of the specimen.

In addition to the above features, the system according to this aspect of the presently disclosed subject matter can comprise one or more of features (i) to (xx) listed below, in any desired combination or permutation which is technically possible:
(i). the one or more parameters comprise one or more structural parameters of the specimen, and one or more parameters informative of one or more materials of the specimen;
(ii). generation of the training set comprises using the model to simulate, for each of a plurality of different values of at least one of one or more structural parameters of one or more specimens, or one or more parameters informative of acquisition by an examination tool, a simulated pixel intensity profile;
(iii). the one or more structural parameters comprise at least one of: depth, critical dimension, thickness, or wall angle;
(iv). the model has been generated by estimating one or more structural parameters of one or more specimens, and one or more parameters informative of one or more materials of the one or more specimens;
(v). the one or more specimens and the given specimen have been manufactured using a same manufacturing process;
(vi). the one or more parameters, informative of the one or more materials of the one or more specimens and of the given specimen, match each other;
(vii). generation of the model comprises determining one or more structural parameters of one or more specimens, for which a simulated pixel intensity profile generated by the model, based on said one or more structural parameters, matches a measured pixel intensity profile of the one or more specimens;
(viii). the one or more structural parameters comprise at least one of: a depth of one or more elements of the one or more specimens, a critical dimension of the one or more elements of the one or more specimens, a top critical dimension of the one or more elements of the one or more specimens, a bottom critical dimension of the one or more elements of the one or more specimens, a middle critical dimension of the one or more elements of the one or more specimens, a wall angle of the one or more elements of the one or more specimens, parameters informative of wall bowing, parameters informative of one or more protrusions;
(ix). generation of the model comprises determining one or more parameters informative of one or more materials of one or more specimens, for which a simulated pixel intensity profile generated by the model, based on said one or more parameters, matches a measured pixel intensity profile of the one or more specimens;
(x). the one or more parameters informative of one or more materials of the one or more specimens comprise at least one of: density, material composition, Fermi level, work function, or bandgap;
(xi). generation of the model comprises optimizing an estimate of one or more structural parameters of one or more specimens, until a simulated pixel intensity profile generated by the model, based on said estimate of said one or more structural parameters, matches a measured pixel intensity profile of the one or more specimens, according to an optimization criterion;
(xii). generation of the model comprises optimizing an estimate of one or more parameters informative of one or more materials of one or more specimens, until a simulated pixel intensity profile generated by the model, based on said estimate of said one or more parameters, matches a measured pixel intensity profile of the one or more specimens, according to an optimization criterion;
(xiii). the model is operative to simulate a first simulation representative of interaction between irradiated electrons of a beam of an examination tool with the semiconductor specimen and a second simulation representative of collection and detection of escaped electrons from the semiconductor specimen;
(xiv). generation of the model comprises repeating at least once a sequence comprising (1) and (2): (1) estimating one or more parameters informative of one or more materials of one or more specimens; (2) estimating one or more structural parameters of one or more specimens;
(xv). the system is configured to obtain a measured pixel intensity profile of one or more specimens, estimate one or more parameters informative of one or more materials of the one or more specimens, by minimizing a difference between a simulated pixel intensity profile of the one or more specimens, obtained based on the model and the estimate of the one or more parameters informative of the one or more materials of the specimen, and a measured pixel intensity profile of the specimen, and estimate one or more structural parameters of the one or more specimens, by minimizing a difference between a simulated pixel intensity profile of the one or more specimens, obtained based on the model, and the estimate of the one or more structural parameters of the one or more specimens, and the measured pixel intensity profile of the one or more specimens;
(xvi). generation of the model comprises generating a first model associated with a first estimate of one or more parameters informative of one or more materials of a first element of a specimen, using the first model, one or more structural parameters of a second element, different from the first element, to generate a simulated pixel intensity profile of the second element, and comparing the simulated pixel intensity profile of the second element with a measured pixel intensity profile of the second element;
(xvii). generation of the model comprises testing the model at different landing energies;
(xviii). generation of the model includes generating a first model associated with a first estimate of one or more parameters informative of one or more materials of a given element of a specimen, obtaining actual structural parameters of the given element of the specimen, based on cutting of said specimen, and using the actual structural parameters and the first model to determine a simulated pixel intensity profile of the given element;
(xix). the system is configured to obtain a landing energy, wherein a relationship between data informative of a dependency of a pixel intensity, or of an electron yield, of one or more specimens, on a depth of the one or more specimens, at said landing energy, and data informative of a dependency of the pixel intensity, or of the electron yield, of the one or more specimens, on one or more other parameters informative of the one or more specimens, at said landing energy, meets a criterion, wherein the data D_{pixel_intensity} have been obtained with said landing energy; and
(xx). the data informative of the pixel intensity profile of the given specimen comprises data informative of a ratio between data informative of a maximal value of a pixel intensity profile in a region of the given specimen, and data informative of a minimal value of the pixel intensity profile in said region of the given specimen.

In accordance with other aspects of the presently disclosed subject matter, there is provided a method comprising, by one or more processing circuitries, obtaining data D_{pixel_intensity} informative of a pixel intensity profile of a given specimen, feeding the data D_{pixel_intensity} to a machine learning model to determine, based on the data D_{pixel_intensity}, data informative of a depth of the given specimen, wherein the machine learning model has been trained with a training set, wherein at least part of the training set has been generated based on a model operative to predict, based on one or more parameters informative of a semiconductor specimen, data informative of a pixel intensity profile of the semiconductor specimen.

These aspects of the disclosed subject matter can comprise one or more of features (i) to (xx) listed above with respect to the system, mutatis mutandis, in any desired combination or permutation which is technically possible.

In accordance with other aspects of the presently disclosed subject matter, there is provided a non-transitory computer readable medium comprising instructions that, when executed by one or more computers, cause the one or more computers to perform: obtaining data D_{pixel_intensity} informative of a pixel intensity profile of a given specimen, feeding the data D_{pixel_intensity} to a machine learning model to determine, based on the data D_{pixel_intensity}, data informative of a depth of the given specimen, wherein the machine learning model has been trained with a training set, wherein at least part of the training set has been generated based on a model operative to predict, based on one or more parameters informative of a specimen, data informative of a pixel intensity profile of the specimen.

These aspects of the disclosed subject matter can comprise one or more of features (i) to (xx) listed above with respect to the system, mutatis mutandis, in any desired combination or permutation which is technically possible.

In accordance with other aspects of the presently disclosed subject matter, there is provided a system comprising one or more processing circuitries configured to determine a landing energy of an examination system, wherein a relationship between:
data informative of a dependency of a pixel intensity, or of an electron yield, of one or more specimens, on a depth of the one or more specimens, at said landing energy, and
data informative of a dependency of the pixel intensity, or of the electron yield, of the one or more specimens, on one or more other parameters informative of the one or more specimens, different from the depth, at said landing energy, meets a criterion.

In addition to the above features, the system according to this aspect of the presently disclosed subject matter can comprise one or more of features (xxi) to (xxxviii) listed below, in any desired combination or permutation which is technically possible:
(xxi). one or more parameters informative of one or more material(s) are similar for the one or more specimens;
(xxii). determination of the data informative of a dependency of the pixel intensity, or of an electron yield, of one or more specimens, on a depth of the one or more specimens, at said landing energy, comprises simulating different depth values of the one or more specimens, and simulating corresponding pixel intensities, or corresponding electron yields, at said landing energy;
(xxiii). determination of the data informative of a dependency of the pixel intensity, or of the electron yield, of the one or more specimens, on one or more other parameters informative of the one or more specimens, at said landing energy, comprises simulating different values of the parameters informative of the one or more specimens, and simulating corresponding pixel intensities, or corresponding electron yields, at said landing energy;
(xxiv). determination of the data informative of a dependency of the pixel intensity, or of the electron yield, of the one or more specimens, at said landing energy, on other parameters informative of the one or more specimens, comprises obtaining data informative of a material of a given element of the one or more specimens, simulating different simulated values of the other parameters of the given element, and using the data informative of the element and a model to simulate, for each of said simulated depth values, a corresponding electron yield, at said landing energy;
(xxv). determination of the data informative of a dependency of the electron yield of the one or more specimens, at said landing energy, on a depth of the one or more specimens, comprises obtaining data informative of a material of a given element of one or more specimens, simulating different simulated depth values of the given element, and using the data informative of the material of the given element and a model to simulate, for each of said simulated depth values, a corresponding pixel intensity, or corresponding electron yield, at said landing energy;
(xxvi). according to said criterion, at said landing energy of the examination system, the relationship is different than at a plurality of other landing energies of the examination system;
(xxvii). a ratio between the data informative of a dependency of a pixel intensity, or of an electron yield, of one or more specimens, on a depth of the one or more specimens, at said landing energy, and data informative of a dependency of the pixel intensity, or of the electron yield, of the one or more specimens, on one or more other parameters informative of the one or more specimens, different from the depth, at said landing energy, meets a criterion;
(xxviii). according to said criterion, at said landing energy of the examination system, the ratio is larger than at a plurality of other landing energies of the examination system;
(xxix). the data informative of a dependency of the pixel intensity, or of the electron yield, of the one or more specimens, on a depth of the one or more specimens, at said landing energy, is informative of an amplitude of variations of the pixel intensity, or of the electron yield of the one or more specimens at said landing energy, with respect to depth variations of the one or more specimens;
(xxx). the data informative of a dependency of the pixel intensity, or of the electron yield, of the one or more specimens, on one or more other parameters informative of the one or more specimens, at said landing energy, is informative of an amplitude of variations of the pixel intensity, or of the electron yield, of the one or more specimens at said landing energy, with respect to variations of said one or more other parameters of the one or more specimens;
(xxxi). the one or more other parameters comprise one or more structural parameters informative of the one or more specimens;
(xxxii). the one or more other parameters comprise at least one of: critical dimension, top critical dimension, bottom critical dimension, middle critical dimension, wall angle, parameters informative of wall bowing, parameters informative of one or more protrusions, thickness;
(xxxiii). the system is configured to obtain data D_{pixel_intensity} informative of a pixel intensity profile of a given specimen at said landing energy, and to feed the data D_{pixel_intensity} to a machine learning model to determine, based on the data D_{pixel_intensity}, data informative of a depth of the given specimen;
(xxxiv). the one or more specimens and the given specimen have been manufactured using a same manufacturing process;
(xxxv). the one or more specimens are simulated to share one or more same manufacturing parameters with the given specimen;
(xxxvi). the one or more parameters, informative of the one or more materials of the one or more specimens and of the given specimen, match each other;
(xxxvii). determining said relationship comprises using a model operative to simulate a first simulation representative of interaction between irradiated electrons of a beam of an examination tool with a specimen; and
(xxxviii). determining said relationship comprises using a model operative to simulate a second simulation representative of collection and detection of escaped electrons from a specimen.

These aspects of the disclosed subject matter can comprise one or more of features (i) to (xx) listed above with respect to the system, mutatis mutandis, in any desired combination or permutation which is technically possible.

In accordance with other aspects of the presently disclosed subject matter, there is provided a method comprising, by one or more processing circuitries, determining a landing energy of an examination system, wherein a relationship between data informative of a dependency of a pixel intensity, or of an electron yield, of one or more specimens, on a depth of the one or more specimens, at said landing energy, and data informative of a dependency of the pixel intensity, or of the electron yield, of the one or more specimens, on one or more other parameters informative of the one or more specimens, different from the depth, at said landing energy, meets a criterion.

These aspects of the disclosed subject matter can comprise one or more of features (xxi) to (xxxviii) listed above with respect to the system, mutatis mutandis, in any desired combination or permutation which is technically possible.

These aspects of the disclosed subject matter can comprise one or more of features (i) to (xx) listed above with respect to the system, mutatis mutandis, in any desired combination or permutation which is technically possible.

In accordance with other aspects of the presently disclosed subject matter, there is provided a non-transitory computer readable medium comprising instructions that, when executed by one or more computers, cause the one or more computers to determine a landing energy of an examination system, wherein a relationship between data informative of a dependency of a pixel intensity, or of an electron yield, of one or more specimens, on a depth of the one or more specimens, at said landing energy, and data informative of a dependency of the pixel intensity, or of the electron yield, of the one or more specimens, on one or more other parameters informative of the one or more specimens, different from the depth, at said landing energy, meets a criterion.

These aspects of the disclosed subject matter can comprise one or more of features (xxi) to (xxxviii) listed above with respect to the system, mutatis mutandis, in any desired combination or permutation which is technically possible.

These aspects of the disclosed subject matter can comprise one or more of features (i) to (xx) listed above with respect to the system, mutatis mutandis, in any desired combination or permutation which is technically possible.

The proposed solution provides various technical advantages. At least some of them are listed hereinafter.

According to some examples, the proposed solution enables accurate determination of the depth profile of a semiconductor specimen, based on an image of the semiconductor specimen.

According to some examples, the proposed solution is mostly a non-destructive approach, which does not require cutting a large number of semiconductor specimens in order to ensure the determination of the depth profile of a fleet of semiconductor specimens.

According to some examples, the proposed solution enables selecting a landing energy of an examination tool which is the most sensitive to the depth variations, thereby facilitating the determination of the depth profile.

According to some examples, the proposed solution generates a large training set using simulations, which alleviates the need for acquiring a large number of training images. The proposed solution is therefore time and cost efficient.

According to some examples, the proposed solution proposes an efficient method of determining depth profile of a specimen, even when the specimen has a complex depth profile.

According to some examples, the proposed solution provides local information on the depth of a specimen, even at small scale.

### BRIEF DESCRIPTION OF THE DRAWINGS

In order to understand the disclosure and to see how it may be carried out in practice, embodiments will now be described, by way of non-limiting example only, with reference to the accompanying drawings, in which:

FIG. 1 illustrates a generalized block diagram of an examination system in accordance with certain examples of the presently disclosed subject matter.

FIG. 2 illustrates a generalized flow-chart of a method of determining depth profile of a specimen.

FIG. 3 illustrates a non-limitative example of data which can be used to determine the depth profile of a specimen.

FIG. 4A illustrates a generalized flow-chart of a method of determining an optimal landing energy for determining the depth profile of a specimen.

FIG. 4B illustrates a non-limitative example of geometrical parameters of a trench.

FIG. 4C illustrates a non-limitative example of an electron beam striking a trench.

FIG. 5 illustrates a non-limitative example of the sensitivity of the pixel intensity (or of the electron yield) to variations in the depth of a trench, for different values of the landing energy.

FIG. 6 illustrates a non-limitative example of the sensitivity of the electron yield to variations in the bottom or top critical dimension of a trench, for different values of the landing energy.

FIG. 7A depicts the sensitivity of the electron yield to depth compared to the sensitivity of the electron yield to top critical dimension, for different values of the landing energy.

FIG. 7B illustrates a generalized flow-chart of a method of determining an optimal landing energy for determining the depth profile of one or more given specimens, and using images of the one or more given specimens acquired at this optimal landing energy, to determine the depth of the one or more given specimens.

FIG. 8 illustrates a generalized flow-chart of a method of generating a model, based on the estimate of one or more geometrical parameters of a specimen, and on the estimate of one or more parameters informative of one or more materials of the specimen.

FIG. 9 illustrates a generalized flow-chart of a method of estimating geometrical parameters of a specimen.

FIG. 10 illustrates a non-limitative example of estimating geometrical parameters of a specimen, in order to minimize the difference between a simulated pixel intensity profile and the measured pixel intensity profile of a specimen.

FIG. 11 illustrates a non-limitative example of the match between a simulated pixel intensity profile provided by a model and the measured pixel intensity profile of a specimen.

FIG. 12A illustrates a generalized flow-chart of updating a model operative to predict a pixel intensity profile of a specimen.

FIG. 12B illustrates a non-limitative example of the method of FIG. 12A.

FIG. 13 illustrates a generalized flow-chart of using physical measurements to update a model operative to predict a pixel intensity profile of a specimen.

FIG. 14 illustrates a generalized flow-chart of a method of testing a model at different landing energies.

FIG. 15 illustrates a generalized flow-chart of a method of generating a training set using simulated data provided by a model.

FIG. 16 illustrates a generalized flow-chart of another method of generating a training set using simulated data provided by a model.

FIG. 17 illustrates a non-limitative example of parameters which can be varied in a model, in order to generate a training set.

FIG. 18 illustrates a generalized flow-chart of a method of training a machine learning model to predict the depth profile based on the pixel intensity profile.

FIG. 19 illustrates a generalized flow-chart of a method of testing the validity of a machine learning model to predict the depth profile.

### DETAILED DESCRIPTION OF EMBODIMENTS

A requirement in the field of semiconductor manufacturing is the measurement of the depth of elements (e.g., trenches, holes, protrusion, etc.) of the semiconductor specimen.

A prior-art approach for measuring the depth profile of a specimen involves cutting a large number of specimens (e.g., hundreds of specimens). This approach is destructive and not efficient.

Proposed hereinafter is an approach which is mainly non-destructive, in that it reduces drastically the need for cutting specimens. According to this approach, the pixel intensity profile (also called grey level intensity profile) of the specimen is obtained based on acquisitions performed by an examination system (such as, but not limited to, a SEM tool). The pixel intensity profile of the specimen (or data informative thereof) is fed to a trained machine learning model, which outputs an estimate of the depth profile of the specimen. The machine learning model has been trained using a training set, which has been generated by using a model.

The model is able to simulate, based on parameters informative of the material of a specimen (e.g., density), structural parameters informative of a specimen (such as, but not limited to, depth, critical dimension) and parameters informative of the examination system (such as, but not limited to, the landing energy), the corresponding pixel intensity profile. For each of a plurality of different values of the one or more structural parameters and of the one or more parameters informative of the material of the specimen, a simulated pixel intensity profile can be obtained by using the model. A large and relevant training set is therefore obtained using simulations, which covers various simulated scenarios. This training set is then used to train the machine learning model. Since generation of the training set is performed mostly using simulations, this alleviates the need for acquiring a large number of SEM images, which is costly and time-consuming.

The parameters of the model have been tuned so as to model, as accurately as possible, the actual parameters of one or more specimens which belong to the same fleet as the specimen under examination. A fleet corresponds to a group of specimens which are manufactured using the same manufacturing parameters, or with substantially the same manufacturing parameters, and which have similar material parameters. Since the model includes parameters which are similar to the parameters of the specimen under examination, it enables generating a relevant training set specifically adapted to the fleet of specimens to which the specimen under examination belongs.

Variations in the measured pixel intensity (which depends, inter alia, on the electron yield) depend not only on the depth variations in the specimen, but also on other variations of the structural parameters of the specimen, such as the critical dimension(s) of the elements (e.g., trenches, holes, etc.) of the specimen. Applicant discovered that it is possible to select an optimal landing energy for which variations in the measured pixel intensity are more sensitive to the depth variations than to other geometrical parameters. Usage of this optimal landing energy for acquiring images of a specimen by an examination tool, facilitates determination of the depth of the specimen.

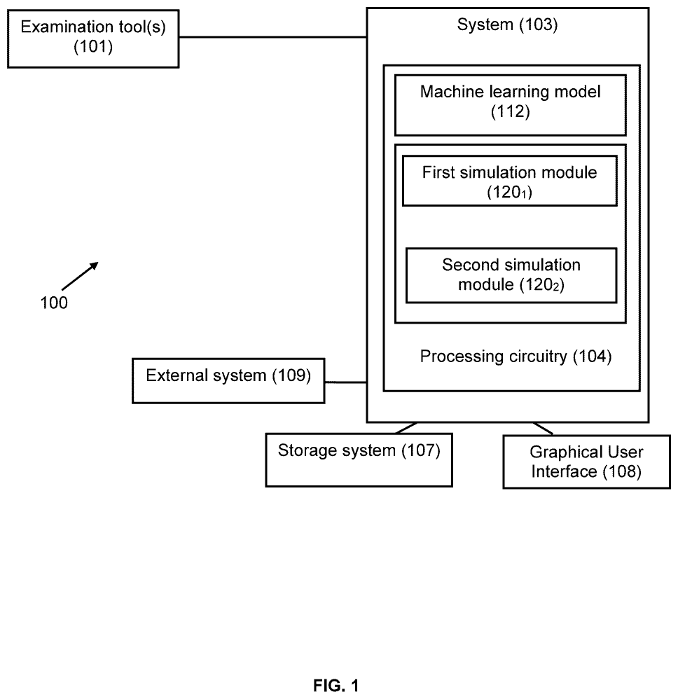

Attention is drawn to FIG. 1 illustrating a functional block diagram of an examination system 100 in accordance with certain examples of the presently disclosed subject matter. The examination system 100 illustrated in FIG. 1 can be used for examination of a specimen (e.g., of a wafer and/or parts thereof) as part of the specimen fabrication process. The illustrated examination system 100 comprises computer-based system 103 capable of automatically determining metrology data using images obtained during specimen fabrication. In some examples, the computer-based system 103 is capable of automatically determining defect-related information using images obtained during specimen fabrication. System 103 can be operatively connected to one or more examination tools 101. The examination tools 101 are configured to capture images and/or to review the captured image(s) and/or to enable or provide measurements related to the captured image(s). In some cases, the same examination tool 101 can provide low-resolution image data and high-resolution image data. In some cases, at least one examination tool 101 can have metrology capabilities.

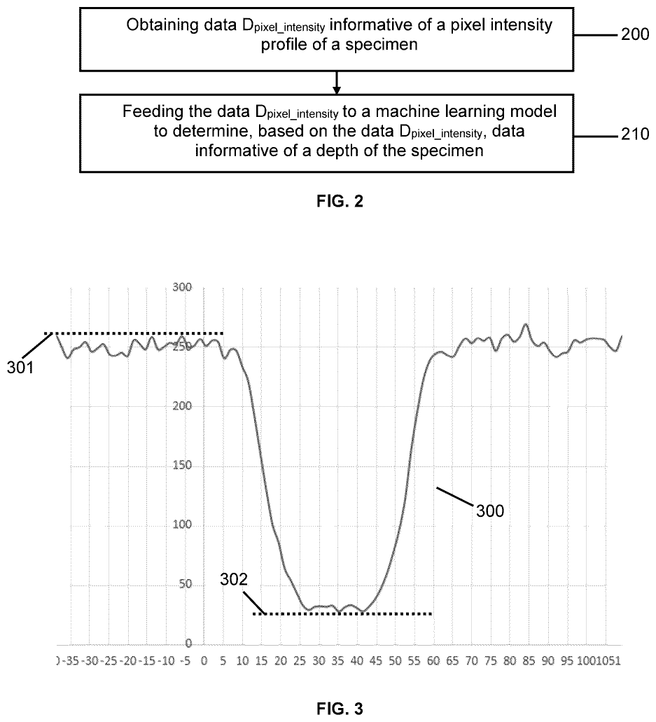

System 103 includes one or more processing circuitries 104. Each processing circuitry 104 includes one or more processors and one or more memories. The processing circuitry 104 is configured to provide all processing necessary for operating the system 103 as further detailed hereinafter (see methods described in FIGS. 2, 4A, 8, 9, 12A, 13, 14, 15, 16, 18 and 19 which can be performed at least partially by system 103 and/or system 100). The one or more processing circuitries 104 are configured to execute operations in accordance with computer-readable instructions implemented on a computer-readable memory of the one or more processing circuitries 104 (or operatively coupled to the one or more processing circuitries 104).

The one or more processing circuitries 104 are configured to execute one or more functional modules in accordance with computer-readable instructions implemented on a non-transitory computer-readable memory of the one or more processing circuitries 104 (or operatively coupled to the one or more processing circuitries 104).

In particular, as visible in FIG. 1, the one or more processing circuitries 104 implement one or more machine learning algorithms 112, such as a deep neural network (DNN). As explained hereinafter, the machine learning algorithm 112 is operative to estimate, based on data informative of the pixel intensity profile of a specimen, the depth profile of the specimen.

By way of non-limiting example, the layers of the machine learning algorithm 112 (e.g., DNN) can be organized in accordance with Convolutional Neural Network (CNN) architecture, such as a fully Convolutional Neural Network (CNN). This is not limitative.

In other examples, the layers of the machine learning algorithm 112 (e.g., DNN) can be organized in accordance with the Recurrent Neural Network architecture, Recursive Neural Networks architecture, Generative Adversarial Network (GAN) architecture, or otherwise. Optionally, at least some of the layers can be organized in a plurality of DNN sub-networks. Each layer of the DNN can include multiple basic computational elements (CE), typically referred to in the art as dimensions, neurons, or nodes.

Generally, computational elements of a given layer can be connected with CEs of a preceding layer and/or a subsequent layer. Each connection between a CE of a preceding layer and a CE of a subsequent layer is associated with a weighting value. A given CE can receive inputs from CEs of a previous layer via the respective connections, each given connection being associated with a weighting value which can be applied to the input of the given connection. The weighting values can determine the relative strength of the connections and thus the relative influence of the respective inputs on the output of the given CE. The given CE can be configured to compute an activation value (e.g., the weighted sum of the inputs) and further derive an output by applying an activation function to the computed activation. The activation function can be, for example, an identity function, a deterministic function (e.g., linear, sigmoid, threshold, or the like), a stochastic function, or other suitable function. The output from the given CE can be transmitted to CEs of a subsequent layer via the respective connections. Likewise, as above, each connection at the output of a CE can be associated with a weighting value which can be applied to the output of the CE prior to being received as an input of a CE of a subsequent layer. In addition to the weighting values, there may be threshold values (including limiting functions) associated with the connections and CEs.

The weighting and/or threshold values of the machine learning algorithm 112 (e.g., DNN) can be initially selected prior to training, and can be further iteratively adjusted or modified during training to achieve an optimal set of weighting and/or threshold values in a trained DNN. After each iteration, a difference (also called loss function) can be determined between the actual output produced by the machine learning algorithm 112 (e.g., DNN) and the target output associated with the respective training set of data. The difference can be referred to as an error value. Training can be determined to be complete when a cost or loss function indicative of the error value is less than a predetermined value, or when a limited change in performance between iterations is achieved. Optionally, at least some of the DNN subnetworks (if any) can be trained separately, prior to training the entire DNN.

The one or more processing circuitries 104 further implement at least one model 120 (also called simulation model). The model 120 is usable to simulate, based on parameters informative of a specimen, and parameters informative of an examination tool, a corresponding simulated pixel intensity. The model 120 can include a first simulation module 1201 and a second simulation module 1202. These two modules will be discussed further hereinafter.

System 103 is configured to receive input data. Input data can include data (and/or derivatives thereof and/or metadata associated therewith) produced by the one or more examination tools 101. It is noted that input data can include images (e.g., captured images, images derived from the captured images, simulated images, synthetic images, etc.) and/or data associated with the images (e.g., pixel intensity profile, such as grey level profile). It is further noted that image data can include data related to a layer of interest and/or to one or more other layers of the specimen. System 103 may send data to the one or more examination tools 101, such as (but not limited to) a command relative to a selected landing energy.

By way of non-limiting example, a specimen can be examined by one or more examination tools 101. The one or more examination tools 101 can include an electron beam examination system, such as a scanning electron microscope (SEM), an optical inspection system (such as, but not limited to, Enlight Optical Inspection System of the Applicant), an Atomic Force Microscopy (AFM), etc. The resulting data (image data) can be transmitted-directly or via one or more intermediate systems—to system 103.

It is noted that image data can be received and processed together with metadata (e.g., pixel size, text description of defect type, parameters of image capturing process, etc.) associated therewith.

Upon processing the input data (image data-if necessary, together with other data as, for example, design data, synthetic data, etc.), system 103 can send instructions to the examination tool(s), store the results (such as data informative of the location of the defects) in a storage system 107, render the results via a computer-based graphical user interface GUI 108, and/or send the results to an external system 109.

Those versed in the art will readily appreciate that the teachings of the presently disclosed subject matter are not bound by the system illustrated in FIG. 1; equivalent and/or modified functionality can be consolidated or divided in another manner and can be implemented in any appropriate combination of software with firmware and/or hardware.

It is noted that the examination system illustrated in FIG. 1 can be implemented in a distributed computing environment, in which the aforementioned functional modules shown in FIG. 1 can be distributed over several local and/or remote devices, and can be linked through a communication network. It is further noted that in other embodiments at least some examination tools 101 and/or 102, data repositories 109, storage system 107 and/or GUI 108 can be external to the examination system 100 and operate in data communication with system 103. System 103 can be implemented as stand-alone computer(s) to be used in conjunction with the examination tools. Alternatively, the respective functions of the system can, at least partly, be integrated with one or more examination tools.

Attention is now drawn to FIG. 2.

Assume that at least one image of at least part of a specimen has been acquired by an examination system (see e.g., examination system 101). The image can be acquired during a run-time examination phase of the specimen.

The image is associated with a pixel intensity profile. This pixel intensity profile describes the evolution of the pixel intensity along one or more axes. Pixel intensity can be expressed e.g., as a grey level intensity, or using any other adapted convention. Note that it can occur that the pixel intensity comprises, for each pixel, a plurality of pixel intensity values, since some examination systems provide different pixel intensity values per pixel.

The method of FIG. 2 includes obtaining (operation 200) data D_{pixel_intensity} informative of a pixel intensity profile of the specimen (also referred to as specimen under examination). As mentioned above, this data can be obtained from the acquisition of the specimen by an examination tool (see e.g., examination tool 101). In some examples, the examination tool is an electron beam examination tool, such as a SEM.

The method of FIG. 2 further includes feeding (operation 210) the data D_{pixel_intensity} to the machine learning model 112 to determine, based on the data D_{pixel_intensity}, data informative of a depth of the specimen. This data can include estimated values of the depth at various locations, such as in a trench, a hole or a bump. This list is not limitative.

In particular, the machine learning model 112 has been trained to determine, based on a pixel intensity profile, the corresponding depth profile. The machine learning model 112 is trained with a training set generated, at least partially, using at least one model (model 120).

In some examples, the model 120 can be generated based on pixel intensity profiles acquired from a set of specimens which are similar to the specimen under examination. For example, the set of specimens and the specimen under examination have been manufactured using the same manufacturing process (with the same manufacturing parameters).

In some examples, the model 120 is generated by estimating parameters informative of one or more specimens, which are similar to the specimen under examination.

For example, the model 120 is generated based on one or more specimens belonging to the same fleet as the specimen under examination. A fleet corresponds to a group of specimens which are manufactured using the same manufacturing parameters, or with substantially the same manufacturing parameters, and which share similar material parameters (e.g., density, composition, etc.).

The model 120 can be generated by estimating one or more structural parameters of the specimen(s) and one or more parameters informative of the material(s) of the specimen(s).

Structural parameters of a specimen delineate the spatial arrangement and dimensional characteristics of the specimen's constituent layers and/or structural features/elements on the layers. Structural parameters can include e.g., geometrical parameters. Structural parameters can include one or more of the following: depth, thickness, geometric dimensions (such as critical dimensions), side wall angle, line width, spacing, parameters informative of wall bowing, parameters informative of protrusions, etc.

Parameters informative of the material(s) of the specimen(s) encompass a multitude of factors that may influence its behavior under electron irradiation. By way of example, the material parameters can comprise one or more of the following: composition (e.g., the elemental composition which may impact the scattering and absorption of electrons), density (e.g., the mass per unit volume of the materials within the specimen, influencing the propagation and attenuation of the electron beam as it traverses through the specimen), stoichiometric formula of materials constituting the specimen, Fermi level, work function, bandgap. The stoichiometric formula can refer to the chemical formula representing the stoichiometry of compounds within the semiconductor layers, which may be needed for accurately modeling the distribution of atoms and the formation of crystal structures.

It is to be noted that the above parameters are listed for exemplary purposes only, and should not be regarded as limited to the list provided above.

Once the model has been generated, the training set can be generated by simulating, for each value of a plurality of simulated values of the one or more structural parameters, a corresponding simulated pixel intensity profile. For example, variations can be performed in the values of the depth, critical dimensions (etc.) and corresponding simulated pixel intensity profiles can be generated by the model 120. The variations in the structural parameters can be performed around the actual values of the structural parameters of the specimen(s) used to generate the model 120. A training set including simulated pixel intensity profiles, each associated with a label informative of the depth profile, is obtained and used to train the machine learning model 112.

Note that the method of FIG. 2 can be performed during run-time examination of the specimen.

In some examples, the data D_{pixel_intensity} fed to the machine learning model 112 corresponds to the pixel intensity profile of the specimen, derived from the image of the specimen acquired by the examination tool 101.

In some other examples, the data D_{pixel_intensity} fed to the machine learning model 112 includes a ratio between data informative of a maximal value of the pixel intensity profile in a region of the specimen (this can include e.g., the maximal value itself, or an aggregate of a plurality of local maximal values, such as an average) and data informative of a minimal value of the pixel intensity profile in this region of the specimen (this can include e.g., the minimal value itself, or an aggregate of a plurality of local minimal values, such as an average). A non-limitative example is provided in FIG. 3, in which the ratio between the maximal value 301 of the pixel intensity profile 300 and the minimal value 302 of the pixel intensity profile 300 can be fed to the machine learning model 112. This approach is much efficient in terms of computation than feeding the full pixel intensity profile to the machine learning model 112 but provides a less accurate determination of the depth.

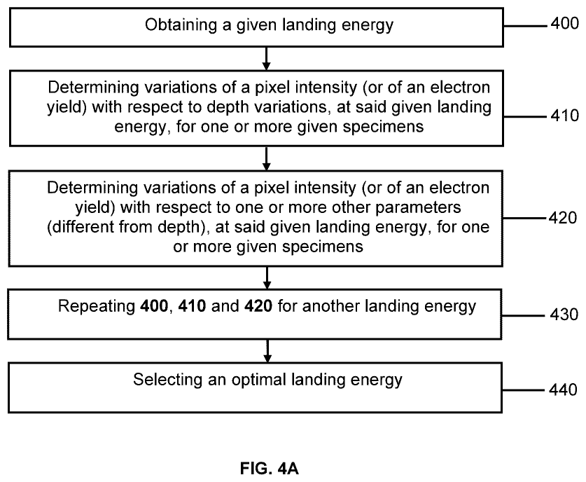

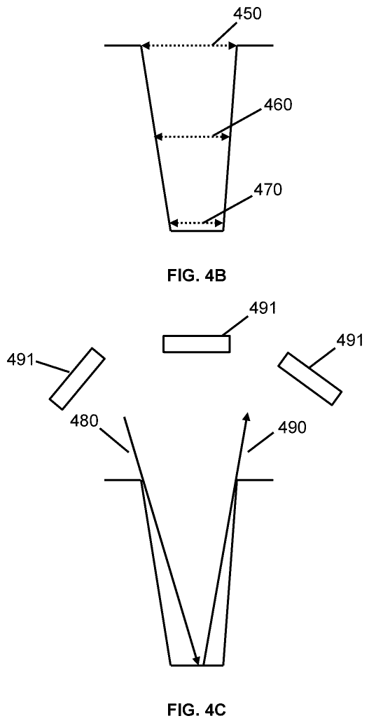

Attention is now drawn to FIG. 4A.

Acquisition of image(s) of the specimen under examination, which enables obtaining the pixel intensity profile of the specimen under examination, is performed using an examination tool 101 with a certain landing energy.

In some examples, the landing energy used to acquire the image(s) of the specimen can be selected using the method of FIG. 4A.

The method of FIG. 4A enables determining a landing energy (or a plurality of landing energies, or a range of landing energies) for acquiring images of a specimen by an examination tool (such as SEM), for which an impact of variations in a depth of the specimen on its pixel intensity profile is higher than an impact of variations in one or more other parameters (which are not depth) informative of the specimen on its pixel intensity profile. The one or more other parameters can correspond to structural parameters informative of the specimen, different from depth. The one or more other parameters include, for example, at least one of: critical dimension (such as top critical dimension-see for example reference 450 in FIG. 4B, medium critical dimension-see for example reference 460 in FIG. 4B, bottom critical dimension-see for example reference 470 in FIG. 4B), side wall angle, parameters informative of wall bowing, parameters informative of protrusions, etc. This is however not limitative.

In other words, it is desired to find a landing energy for which there is a high sensitivity of the electron yield (or more generally of the measured pixel intensity profile) to depth, and a small sensitivity of the electron yield (or more generally of the measured pixel intensity profile) to other parameters (e.g., CD) informative of the specimen. This optimal landing energy facilitates determination of the depth of the specimen based on its pixel intensity profile.

As described above, various types of examination tools can be used for performing examination of a semiconductor specimen, such as, e.g., optical inspection tools, electron beam tools, etc. By way of example, scanning electron microscopes (SEMs) are electron microscopes that produce images of a specimen by scanning the specimen with a focused beam of electrons. A SEM is capable of accurately inspecting and measuring features during the manufacture of semiconductor wafers. The electrons interact with atoms in the specimen, producing various signals that contain information on the surface topography and/or composition of the specimen.

Specifically, when an electron beam 480 strikes a specimen (see FIG. 4C), electrons 490 are backscattered by the specimen, and sensed by detectors 491 of the examination tool. This produces a signal (pixel intensity signal) informative of the specimen. For a given region of the specimen (such as the bottom of a trench, or of a hole), the electron yield is informative of the ratio between the quantity of backscattered electrons by this region, and the quantity of electrons of the electron beam striking this region.

The backscattered electrons are then collected and detected by the detectors of examination tool. The detectors generate a corresponding signal, which correspond to the pixel intensity profile of the specimen. In other words, the pixel intensity profile depends on the electron yield, and on the collection and detection properties of the examination system.

The method of FIG. 4A can include testing, for each of a plurality of landing energies, the variations of the pixel intensity signal (or of the electron yield), with respect to variations of the depth, and the variations of the pixel intensity signal (or of the electron yield), with respect to variations of one or more other parameters, different from the depth. This can be performed by simulations.

In particular, the method of FIG. 4A includes obtaining (operation 400) a given landing energy. The method further includes (operation 410) determining variations of the pixel intensity signal (or of the electron yield) with respect to depth variations, at this given landing energy.

The method of FIG. 4A can be performed on one or more given specimens, with certain material parameters and structural parameters. The material parameters and the structural parameters may be provided by a manufacturer, and/or extracted from design data of the specimens. A model (such as model 120), operative to simulate the pixel intensity profile based on parameters of a specimen, may be fed with these parameters. Note that the one or more given specimens can correspond to specimens which are simulated.

Operation 410, in which the sensitivity of the pixel intensity profile on the depth is tested at a given landing energy, can be performed by acquiring and/or simulating different images/pixel intensity profiles of the one or more given specimens at this given landing energy, for different values of the depth of the one or more given specimens.

In some examples, the simulation can be performed on a given element (representative element) of the given specimen(s), such as a trench, for which the depth profile is varied by simulation, and the corresponding simulated pixel intensity profile is generated using a model. Note that the variations of the depth profile can be performed around the nominal value of the depth profile of the given element of the one or more given specimens. The nominal value of the depth profile can be provided by the manufacturer and/or extracted from CAD design. This is not limitative. The simulation can include using, in the simulation model 120, data informative of the material of the given element of the one or more given specimens, to simulate, for different simulated depth values of the given element, a corresponding simulated pixel intensity profile, at the given landing energy.

Assume that at this given landing energy, for a first value D₁ of the depth of a trench of a given specimen, a first value PI₁ of the simulated pixel intensity (or of the electron yield) is obtained for the bottom of the trench. For a second value D₂ of the depth of the trench, a second value PI₂ of the simulated pixel intensity (or of the electron yield) is obtained. For a third value D₃ of the depth of the trench, a third value PI₃ of the simulated pixel intensity (or of the electron yield) is obtained. Note that the different depth values can correspond to simulated depth values, which are injected in a model in order to simulate the corresponding pixel intensity. The set of values (PI₁ to PI₃; D₁ to D₃) is informative of the dependency of the pixel intensity of the specimen on the depth of the specimen, at the given landing energy. In particular, this set of values is informative of a sensitivity of the pixel intensity to the depth variations, at the given landing energy. Note that the same process can be performed by simulating the variations of the electron yield with respect to the depth variations.

The method further includes (operation 420) determining variations of the pixel intensity (or of the electron yield) with respect to variations of structural parameters informative of the one or more given specimens, which are different from depth (such as, but not limited to, critical dimension, side wall angle, parameters informative of wall bowing, parameters informative of protrusions, etc.). This can be performed by acquiring and/or simulating different images of the one or more given specimens, at this landing energy, for different values of each parameter.

In some examples, the simulation can be performed on a given element of the given specimen(s), such as a trench, for which the value of each structural parameter is varied by simulation, and the corresponding simulated pixel intensity profile is generated using a model. Note that the variations of the values of the parameters can be performed around the nominal value of the parameters of the one or more given specimens. The nominal value of the parameters can be provided by the manufacturer and/or extracted from CAD design. This is not limitative. The simulation can include using, in the simulation model 120, data informative of the material of the given element of the one or more given specimens, to simulate, for different simulated values of the structural parameters of the given element (e.g., CD, etc.), a corresponding simulated pixel intensity profile, at the given landing energy.

Assume that at this given landing energy, for a first value CD₁ of the critical dimension of a trench, a first value PI′₁ of the simulated pixel intensity (or of the simulated electron yield) is obtained. For a second value CD₂ of the critical dimension of the trench, a second value PI′₂ of the simulated pixel intensity (or of the simulated electron yield) is obtained. For a third value CD₃ of the critical dimension of the trench, a third value PI′₃ of the simulated pixel intensity (or of the simulated electron yield) is obtained. Note that the different values of the critical dimensions can correspond to simulated critical dimensions, which are injected in a model in order to simulate the corresponding pixel intensity. The set of values (PI′₁ to PI′₃; CD₁ to CD₃) is informative of the dependency of the pixel intensity of the one or more given specimens on the critical dimension of the one or more given specimens, at the given landing energy. In particular, the set of values (PI′₁ to PI′₃; CD₁ to CD₃) is informative of the sensitivity of the pixel intensity to the critical dimension, at the given landing energy. Note that the same process can be performed by simulating the variations of the electron yield with respect to the variations of parameters different from depth, such as the critical dimension.

Operation 420 can be performed for a plurality of different structural parameters (different from depth). Assume that at this given landing energy, for a first value SWA₁ of the side wall angle of a trench, a first value PI″₁ of the pixel intensity is obtained. For a second value SWA₂ of the side wall angle of the trench, a second value PI″₂ of the pixel intensity is obtained. For a third value SWA₂ of the side wall angle of the trench, a third value PI′″₃ of the pixel intensity is obtained. The set of values (P′″₁ to P′″₃; SWA₁ to SWA₃) is informative of dependency of the pixel intensity of the one or more given specimens on the side wall angle of the one or more given specimens, at the given landing energy. In particular, the set of values (PI′″₁ to PI′″₃; SWA₁ to SWA₃) is informative of the sensitivity of the pixel intensity to the side wall angle, at the given landing energy. Note that the same process can be performed by simulating the variations of the electron yield with respect to the variations of parameters different from depth, such as the side wall angle.

The method of FIG. 4A (in particular operations 400, 410, and 420) can be then repeated (see operation 430) for a different value of the landing energy. The sequence of operations 400, 410, 420, and 430 can be repeated for a plurality of values of the landing energy.

The method of FIG. 4A can then include (operation 440) selecting an optimal landing energy. This optimal landing energy can be selected, such that a ratio between a sensitivity of the pixel intensity (or of the electron yield) to depth variations, and a sensitivity of the pixel intensity (or of the electron yield) to variations of one or more other parameters (different from depth) meets a criterion. The criterion can require that the ratio is above a threshold.

In particular, the landing energy can be selected such that a relationship between data informative of a dependency of a pixel intensity (or of an electron yield) of the one or more given specimens at said landing energy, on a depth of the one or more given specimens, and data informative of a dependency of a pixel intensity (or of an electron yield) of the one or more given specimens at said landing energy, on one or more other parameters informative of the one or more given specimens, meets a criterion. The relationship can correspond to the fact that the ratio between the data informative of a dependency of a pixel intensity (or of an electron yield) of the one or more given specimens at said landing energy, on a depth of the one or more given specimens, and the data informative of a dependency of the pixel intensity (or of the electron yield) of the one or more given specimens at said landing energy, on one or more other parameters informative of the one or more given specimens, meets the criterion. The criterion can require that the ratio is above a threshold.

During the simulation, although the depth values and other structural parameters are varied, parameters informative of the material of the one or more given specimens can be maintained constant. In particular, the parameters informative of the material of the one or more given specimens can be the same, or similar with a difference between a threshold, among the one or more given specimens. The threshold can be selected such that the impact of the variations in the material parameters is negligible. This enables selecting an optimal landing energy, which provides a higher sensitivity to depth than to other parameters, for specimen(s) sharing similar material properties.

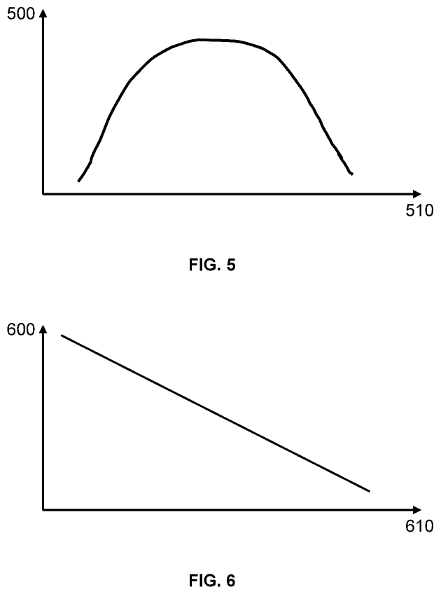

FIG. 5 illustrates a non-limitative example of the sensitivity (see axis 500—a high value in this axis corresponding to a high sensitivity) of the pixel intensity (or electron yield) to variations in the bottom or top critical dimension of a trench, for different values of the landing energy (axis 510).

FIG. 6 illustrates a non-limitative example of the sensitivity (see axis 600—a high value in this axis corresponding to a high sensitivity) of the pixel intensity (or electron yield) to variations in the bottom or top critical dimension of a trench, for different values of the landing energy (axis 610). The curves depicted in FIGS. 5 and 6 (or other data derived from these curves) can be used to find a landing energy for which there is a high sensitivity of the pixel intensity (or electron yield) to depth variations, and a small sensitivity of the pixel intensity (or electron yield) to variations in bottom or top critical dimension.

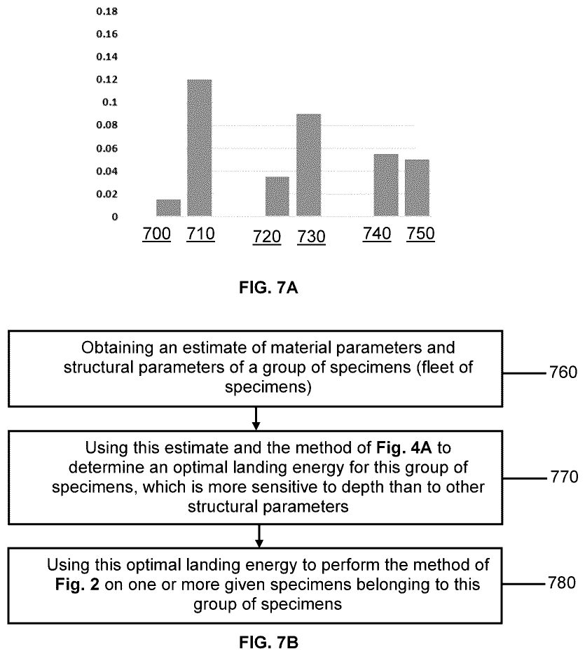

FIG. 7A depicts sensitivity to depth 710 compared to sensitivity to top critical dimension 700 for a first landing energy, sensitivity to depth 730 compared to sensitivity to top critical dimension 720 for a second landing energy and sensitivity to depth 750 compared to sensitivity to top critical dimension 740 for a third landing energy. The first landing energy is most adapted, since the ratio between the sensitivity to depth and the sensitivity to the top critical dimension is the largest.

The landing energy determined using the method of FIG. 4A can be used to acquire images of the specimen, and, in turn, to obtain the data D_{pixel_intensity} informative of a pixel intensity profile of the specimen used in the method of FIG. 2 to determine the depth profile.

As mentioned above, in order to determine the landing energy using the method of FIG. 4A, a model 120 can be used.

The model 120 can include structural parameters informative of the specimen (e.g., depth, critical dimension), parameters informative of the material(s) of the specimen (e.g., density, material composition, Fermi level, work function, bandgap, etc.) and the landing energy. Based on these various parameters, the model 120 is configured to simulate (using Monte-Carlo simulations) the corresponding electron yield (or, more generally, the corresponding pixel intensity).

The model 120 can be used to simulate the pixel intensity profile and/or the electron yield of a specimen, for different values of the depth (operation 410) and/or to determine the electron yield for different values of other parameters, different from the depth (operation 420). The value of the depth, of the other parameters (critical dimension, etc.) and the value of the landing energy can be injected in the model 120 to determine the corresponding electron yield. This enables testing the sensitivity of the electron yield to the depth and to the other parameters of the specimen.

In some examples, the model 120 can include a first simulation module 1201 implementing a first simulation model which models the electron yield, and a second simulation module 1202 which models collection and detection of the electrons by the detectors of the examination tool.

The first simulation module 1201 can be configured to perform, based on the material parameters and structural parameters of a semiconductor specimen, a first simulation representative of interaction between irradiated electrons of a beam (primary beam) of the examination tool (in particular, an electron beam tool) and the specimen. Note that the first simulation module 1201 can take into account parameters of the beam (see examples hereinafter) generated by the examination tool. The first simulation module 1201 can output data informative of the electron yield of the specimen irradiated by the beam. In some examples, the first simulation module 1201 can output a map representative of distribution of escaped electrons in terms of polar angle and escape energy.

An examination tool, such as an electron beam tool, is typically configured with multiple tool parameters characterizing the tool, including, such as, e.g., a set of primary beam parameters and a set of tool imaging parameters. By way of example, the set of beam parameters characterize the beam emitted from the electron source of the electron beam tool, and can comprise at least some of the following parameters: landing energy, beam resolution, current amplitude, current density, electron source characteristics, lens settings, aperture size, and numerical aperture (NA), which collectively define the characteristics of the primary beam, such as the spatial extent and focus of the beam.

For each landing energy, the first simulation simulates the beam being directed towards the specimen, where interactions occur based on the material parameters and structural parameters previously defined. By way of example, electron-solid interactions, including secondary electron emission, electron back-scattering, absorption, etc., can be simulated to elucidate the distribution and behavior of primary and escaped electrons within the specimen. The simulation can also track the trajectories of irradiated electrons as they traverse through the specimen, considering the effects of parameters, such as varying landing energy, beam resolution, and current density, on electron transport and interaction mechanisms within the material.

Upon interaction with the specimen, a subset of electrons, such as secondary electrons (SEs), and/or backscattered electrons (BSEs), may escape from the specimen surface, carrying information on its composition, dimensions, defectivity, and surface characteristics. The traces of these escaped electrons are tracked using a tracing algorithm, accounting for their energy, direction, and scattering behavior as they propagate through the tool. Specifically, in some embodiments, the tracing algorithm can use two models, a model characterizing the electron beam tool's column (which houses the electron source and lenses) (also referred to as a column model), and a model characterizing the electron beam's chamber (e.g., the vacuum chamber housing the specimen) (also referred to as a chamber model).

By way of example, the column model can be constructed, incorporating geometrical dimensions and material compositions of each component in the column to simulate electron optics and beam propagation. This model accounts for electron scattering, focusing, and deflection mechanisms within the column, ensuring accurate representation of electron trajectories as they interact with the specimen. A chamber model can be developed to characterize the electrostatic and electromagnetic fields within the machine chamber surrounding the electron beam tool. This model considers the spatial distribution of charge, potential, and magnetic fields generated by the electron beam and other system components, such as vacuum pumps, shielding, and stage mechanisms.

For each landing energy, the first simulation can generate output data, e.g., in the form of a map, representing the spatial distribution of escaped electrons in terms of polar angle and escape energy.

The term “polar angle” refers to the angle measured from a reference axis (e.g., the optical axis, which is the surface normal) to the direction in which an electron escapes from the specimen. In the context of electron microscopy, this angle provides information on the directionality of electron emission from the specimen surface. A polar angle of 0 degrees would correspond to electrons escaping perpendicular to the surface, while larger angles represent deviations from this perpendicular direction. The term “escape energy” represents the kinetic energy of the escaped electrons as they leave the specimen surface.

The second simulation module 1202 can be configured to perform a second simulation representative of collection and detection of the escaped electrons. The second simulation module 1202 can receive, as an input, the output of the second simulation module 1202, such as the map. The second simulation module 1202 can simulate the pixel intensity profile of the specimen.

The set of tool imaging parameters, as part of the tool parameters. characterize the collection and detection of the escaped electrons so as to form an imaging signal. By way of example, the set of tool imaging parameters can comprise at least some of the following parameters: detector angle, detector gain, defector offset, electrostatic field, voltage, mechanical configuration, dwell time, scanning speed, pixel size, and energy filter of the electron beam tool.

For each landing energy, the second simulation models the collection of escaped electrons by different detectors positioned at specific angles and orientations relative to the specimen. The output map from the first simulation can be used as an input to the second simulation, to determine the expected distribution of escaped electrons entering different detectors. This involves modeling the trajectories of escaped electrons as they travel from the specimen surface to the detectors. The efficiency of electron collection can be influenced by parameters such as, e.g., detector angle, deflector offset, and electrostatic field, which determine the trajectories of escaped electrons towards the detectors.

The second simulation model 1202 then models the detection of the collected electrons by the detectors to generate a simulated pixel intensity profile. In one example, the signal detected by a given detector can be simulated, based on a correlation between the detector gain and the hitting energy (e.g., the energy level at which the electrons hit/enter the detector, also referred to as energy of incoming electrons of the detector), and optionally also hitting current (e.g., the current level at which the electrons hit/enter the detector, also referred to as current of incoming electrons of the detector).

Attention is now drawn to FIG. 7B.

In some examples, the method of FIG. 4A is used in conjunction with the method of FIG. 2. Assume that it is desired to determine the depth profile of a group of specimens (also called fleet of specimens). This fleet of specimens includes specimens which share similar manufacturing conditions. Although the material and structural parameters of this fleet of specimens should be similar according to the design intent, they can vary due the manufacturing errors. Assume that an initial estimate of the parameters of the specimens of this fleet is available, e.g., from the manufacturer. Note that this is only an estimate, since the actual parameters differ from the indented design, due to errors in the manufacturing process. This initial estimate includes an estimate of structural parameters informative of the specimen (e.g., depth, critical dimension) and parameters informative of the material(s) of the specimen (e.g., density, material composition, Fermi level, work function, bandgap, etc.).

This initial estimate can be used in the method of FIG. 4A. This initial estimate can be injected into the model 120. Then, when testing the dependency of the pixel intensity (or electron yield) on the different structural parameters (depth, critical dimension, etc.) at a given landing energy, it is possible to vary the values of the parameters and simulate the corresponding pixel intensity (or electron yield). The method of FIG. 4A enables selecting an optimal landing energy, for which the sensitivity to depth variations is higher than the sensitivity to the variations of other structural parameters. This optimal landing energy is specifically adapted to this fleet of specimens, since the model includes parameters adapted to this fleet of specimens. In other words, the optimal landing energy is determined for one or more specimens which are similar (similar structural parameters and material parameters) to the given specimen for which the depth profile has to be determined based on its pixel intensity profile using the method of FIG. 2.

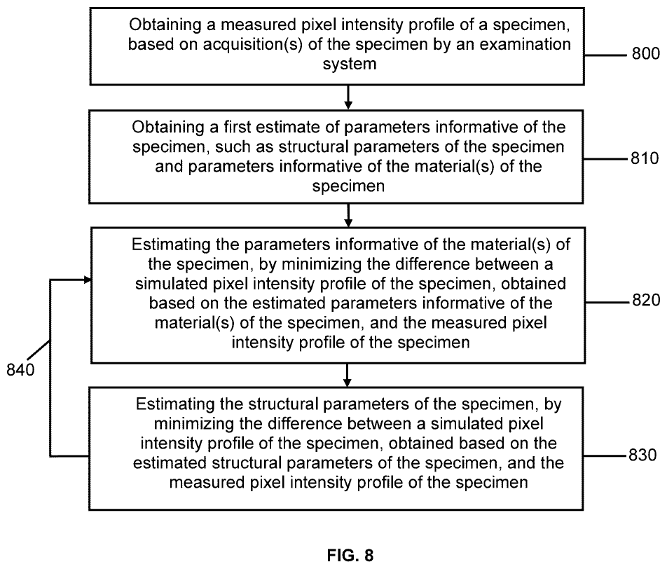

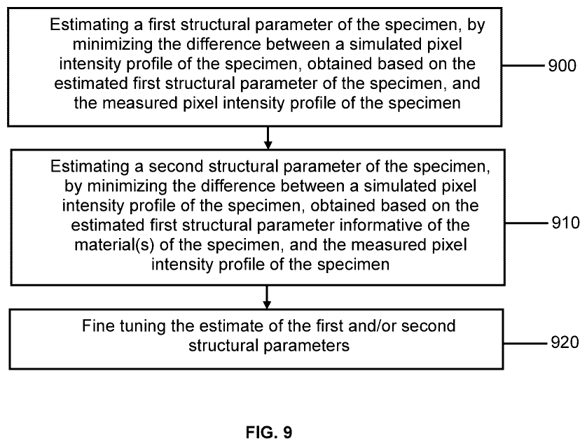

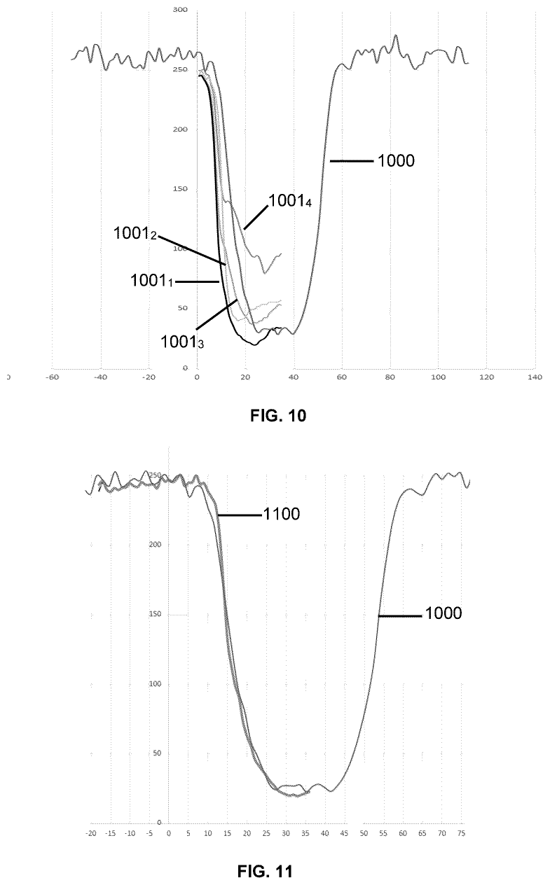

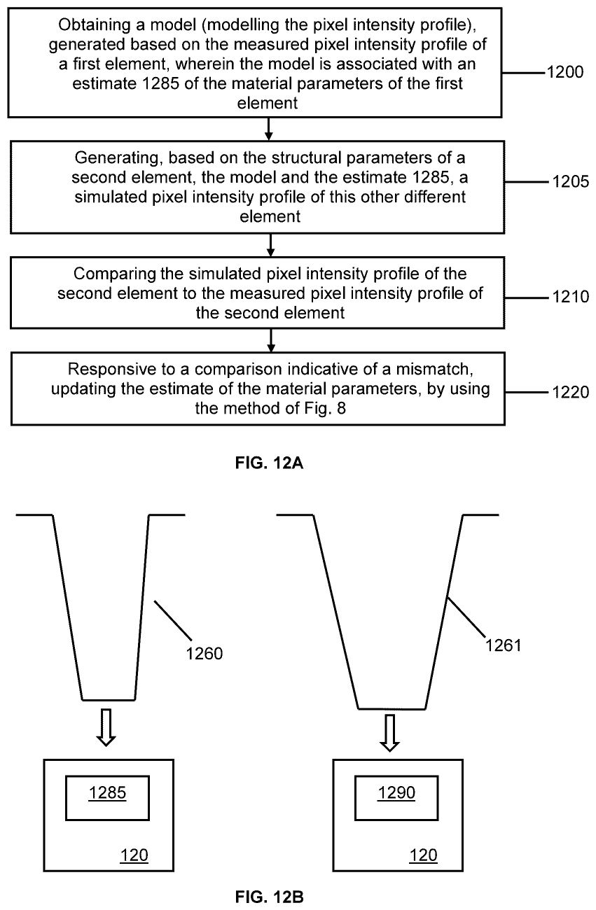

As explained hereinafter with reference to FIGS. 8 and 9, once the optimal landing energy has been determined, the estimate of the material parameters and the structural parameters of the fleet of specimens can be further fine tuned in the model 120, which is then used to generate a training set for training the machine learning model 112. In other words, when determining the optimal landing energy, a model 120 which contains an initial estimate of the material parameters and of the structural parameters, is used. When generating the training set, a model 120 which contains a more accurate estimate of the material parameters and the structural parameters is used. This is not limitative.

Attention is now drawn to FIG. 8. As mentioned with reference to FIG. 2, a machine learning model 112 can be fed with data informative of the pixel intensity of a given specimen, and outputs data informative of a depth of the given specimen.

The machine learning model 112 has been trained with a training set. FIG. 8 proposes a method of generating the training set. This method relies mostly on simulations. In particular, the method of FIG. 8 proposes to use the model 120 operative to simulate, based on one or more parameters informative of a specimen (such as, but not limited to, structural parameters of the specimen, parameters informative of a material of the specimen), and one or more parameters informative of the examination tool (such as the landing energy), the corresponding pixel intensity profile (grey level intensity profile).

It has been mentioned with reference to FIG. 4A, that the model 120 can be used to determine an optimal landing energy. As mentioned in FIG. 7B, the model 120 used in the method of FIG. 4A can rely on assumptions on structural parameters and material parameters of a fleet of specimens. In the method of FIG. 8, the model 120 (and in particular, the first simulation module 1201) is further improved by attempting to estimate the actual values of the parameters informative of the material(s) of the fleet of specimens. Note that in order to obtain the estimate of the actual values of the parameters informative of the material(s) of the fleet of specimens, this can require estimating also the actual structural parameters of one or more specimens of the fleet, as explained hereinafter.

The method of FIG. 8 includes obtaining (operation 800) a pixel intensity profile (or, equivalently, electron yield) of at least one specimen, based on acquisition(s) of the at least one specimen by an examination tool (such as a SEM). The specimen can be a representative specimen of the fleet. Although the method of FIG. 8 generates a model 120 based on the acquisition of images of a specimen (or of a plurality of specimens), this model 120 is valid for the fleet of specimens, which are similar according to a similarity criterion, as mentioned above.

The model 120 is used to generate a training set for training the machine learning model 112 used in the method of FIG. 2, for predicting the depth profile of a given specimen. The model 120 is valid for specimens which are similar according to a similarity criterion. In particular, the model 120 is valid for specimens which have the same parameters informative of their material(s) (e.g., same density, same composition, etc.), or which differ by a negligible difference.

The method of FIG. 8 further includes obtaining (operation 810) a first estimate of parameters informative of the specimen, such as (but not limited to), structural parameters (depth, critical dimension, etc.) and parameters informative of the material(s) of the specimen (e.g., material composition, density, Fermi level, work function, bandgap, etc.). This first estimate can be provided e.g., by the manufacturer of the specimen. There is generally a difference between the first estimate and the actual value of the parameters of the specimen, since the manufactured specimen can differ from the intended design.

The method of FIG. 8 further includes estimating (operation 820) the parameters informative of the material(s) of the specimen. This can be performed by attempting to minimize the difference between a simulated pixel intensity profile (or simulated electron yield) of the specimen (obtained based on the estimated parameters informative of the material(s) of the specimen) and the measured pixel intensity profile (or the measured electron yield) of the specimen, obtained at operation 800. Note that operation 820 can be performed on a representative element of the specimen, such as a representative trench, and not necessarily on the whole wafer. Indeed, it can be assumed that the parameters of the material used in the representative trench are constant throughout the specimen. Generation of the simulated electron yield can be performed using the model 120, in which the values of the parameters of the material (as estimated in the current optimization) and the estimated values of the structural parameters (as provided by the manufacturer) are used.

An optimization process can be performed, in which an estimate of parameters informative of the material(s) is searched under the constraint of minimizing the difference between the simulated pixel intensity (or the simulated pixel electron yield) and the measured pixel intensity profile (or the measured electron yield). In some examples, the optimization process can include classifying the parameters based on their dominance. Optimization of the most dominant parameters should be assigned the highest priority with respect to other less dominant parameters. The optimization process can also include determining the impact of each parameter on the other parameters. Parameters which have a small influence on other parameters can be optimized first. Completion of operation 820 enables estimating parameters of the material of the specimen, such as (but not limited to), composition, density, Fermi level, work function, bandgap, etc.

Once the parameters informative of the material(s) of the specimen have been estimated, the method can further include (operation 830) estimating one or more of the structural parameters of the specimen.

In particular, operation 830 can include determining one or more structural parameters of the specimen, for which a simulated pixel intensity profile, generated by the model based 120 on said one or more structural parameters, matches the measured pixel intensity profile of the specimen (obtained at operation 800).

This can include performing an optimization process. This optimization process can include optimizing an estimate of one or more structural parameters of the specimen, until a simulated pixel intensity profile generated by the model, based on said estimate of said one or more structural parameters, matches the measured pixel intensity profile of the specimen.

Note that it is possible to repeat a plurality of times a sequence including operation 820 (estimating the parameters informative of the material) and operation 830 (estimating the structural parameters of the specimen), as illustrated in operation 840. In other words, operation 820 is performed, then operation 830, then again operations 820 and 830, until a criterion is met. The criterion can dictate that the difference between the simulated pixel intensity profile and the measured pixel intensity profile is below a threshold.

Note that operation 830, in which the structural parameters of the specimen are estimated, can be performed using an iterative process, in which each structural parameter is estimated, one after the other. This is illustrated in FIG. 9. This can include (operation 900) optimizing an estimate of a first structural parameter (e.g., depth) of the specimen, until a simulated pixel intensity profile generated by the model 120, based on the estimate of the first structural parameter, matches the measured pixel intensity profile of the specimen. The match can be such that an optimization criterion is met, that is to say that the difference between the simulated pixel intensity profile and the measured pixel intensity profile is below a threshold, or is minimized.

A non-limitative example of operation 900 is depicted in FIG. 10, which illustrates the measured pixel intensity profile 1000 and a plurality of simulated pixel intensity profiles 10011, 10012, 10013, and 10014 for different estimates of the depth.

Then, the method can include (operation 910) optimizing an estimate of a second structural parameter (e.g., top critical dimension) of the specimen, such that a simulated pixel intensity profile generated by the model 120, based on the estimate of the second structural parameter, matches the measured pixel intensity profile of the specimen. The match can be such that an optimization criterion is met, that is to say that the difference between the simulated pixel intensity profile and the measured pixel intensity profile is below a threshold, or is minimized.

If required, the method can include optimizing an estimate of a third structural parameter (e.g., bottom critical dimension) of the specimen, such that a simulated pixel intensity profile, generated by the model 120 based on the estimate of the third structural parameter, matches the measured pixel intensity profile of the specimen. The match can be such that an optimization criterion is met, that is to say that the difference between the simulated pixel intensity profile and the measured pixel intensity profile is below a threshold, or is minimized.

Note that the method can be used to estimate any number N of structural parameters. This number N can be any integer greater than one or two.

Once an estimate of each of the structural parameters has been obtained, it is possible to repeat the method iteratively. In particular, the method can include fine tuning (operation 920) the estimate of the first and/or second structural parameters (or any of the N structural parameters).

For example, the method of FIG. 9 can include fine-tuning the estimate of the depth, such that the simulated pixel intensity profile generated by the model 120, based on said new estimate of the depth, better matches the measured pixel intensity profile of the specimen according to a criterion. It can then include fine-tuning the estimate of the other parameters.

The method can be repeated iteratively until the required number (which can be any integer greater than one or two) of structural parameters of the specimen has been estimated.

FIG. 11 illustrates the measured pixel intensity profile 1000 and the simulated pixel intensity profile 1100 obtained after performing, at least once, the method of FIG. 8. As visible in FIG. 11, the estimate of the material parameters and of the structural parameters has enabled obtaining a simulated pixel intensity profile 1100 which is close to the measured pixel intensity profile 1000.

Attention is now drawn to FIGS. 12A and 12B.

In some examples, a model 120 has been generated (operation 1100), as described in FIG. 8, based on the measured pixel intensity profile of a first element, such as a representative trench 1260 of the specimen (or another element, such as a hole, etc.). This model 120 is associated with an estimate 1285 of the material parameters of the specimen. As mentioned with reference to FIG. 8, the estimate 1285 is generated by comparing the simulated pixel intensity profile of the trench 1260 of a specimen (or of another element of the specimen) to local measurements of the pixel intensity profile of the trench (or of another element of the specimen).

Then, the model 120, associated with the estimate 1285 of the material parameters, is tested on another element of the specimen (or of another similar specimen, belonging to the same fleet of specimens), different from the given element. For example, the model 120, associated with the estimate 1285 of the material parameters, is tested on a trench 1261 with different dimensions than the trench 1260. This is not limitative, and a different type of element can be used (e.g., hole, etc.). Note that the second element on which the model 120 is tested can be of a different type than the first element used to determine the estimate 1285 of the material parameters.

The model 120 is used to generate (operation 1205), based on the structural parameters (e.g., critical dimensions, depth, etc.) of the other trench 1261, and the estimate 1285 of the material parameters estimated on the trench 1260, a simulated pixel intensity profile. The structural parameters of the other trench 1261 can be obtained from design data, and/or from a user, such as the manufacturer of the specimen. The simulated pixel intensity profile of the trench 1261 is compared (operation 1210) to the measured pixel intensity profile of the trench 1261. Depending on the comparison, it can be decided whether the model needs to be updated (operation 1220). If there is a mismatch, at least part of the method of FIG. 8 can be repeated, in order to generate a model 120 associated with an updated estimate 1290 of the material parameters. The method of FIG. 8 can be repeated on the element 1260, or on the element 1261, or on another element. During the repetition of the method of FIG. 8, the estimate of the parameters of the material of the specimen can be further fine-tuned. Operation 820 can be used to perform this fine-tuning. This enables obtaining a more accurate model 120, in which the parameters informative of the material of the specimen are closer to their actual values. The method of FIG. 12A can be repeated on various elements of the same specimen, or another specimen of the fleet.

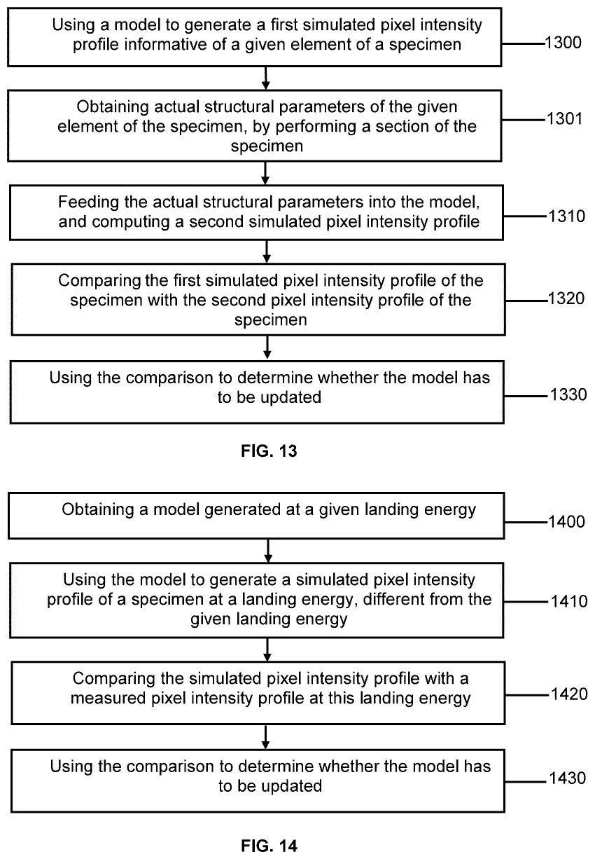

Attention is now drawn to FIG. 13.

In some examples, the method of FIG. 13 can be performed once the method of FIG. 12A or of FIG. 8 has been performed.

The method of FIG. 13 can be used to further fine-tune the model 120, informative of a fleet of specimens. In particular, it can be used to further fine-tune the estimate of the material parameters used in the model 120, for this fleet of specimens.

Assume that the model 120 enables generating a first simulated pixel intensity profile informative of a given element of a specimen (operation 1300). For example, the given element is a trench.

The method includes obtaining (operation 1301) physical data of the specimen (or of one or more other specimens of the fleet). The physical data can include actual structural parameters of the specimen, obtained by performing a physical cross-section of the specimen (cutting of the wafer). The actual structural parameters can include the real dimensions (real geometrical parameters) of elements of the specimen, obtained by performing a physical cross-section of the specimen (cutting of the wafer). Note that it is not necessary to perform physical cross-sections of a large number of specimens of the fleet, but it is enough to obtain a few cross-sections of some specimens (e.g., less than 10, for example 6—this is not limitative).

The method includes feeding (operation 1310) the actual structural parameters of the given element of the specimen into the model 120, and computing a second simulated pixel intensity profile of the given element. Operation 1310 can be performed on one or more elements of the specimen.

The method further includes comparing (operation 1320) the first simulated pixel intensity profile with the second simulated pixel intensity profile.

This comparison can be used to determine whether the model has to be updated (operation 1330). If the second simulated pixel intensity profile differs from the first simulated intensity pixel intensity profile by a significant difference (above a threshold), this can be used as an indication that the model needs to be updated. Update of the model can be performed by repeating operation 820, in order to fine-tune the estimate of the parameters informative of the material of the specimen. If this is not the case, it is possible to keep the model without updating it.

In some examples, it possible to compare the second simulated pixel intensity profile with the measured pixel intensity profile of the given element. The measured pixel intensity profile of the given element has been obtained by acquiring image(s) of the specimen by an examination tool, before performing the cross-section. A difference above a threshold can be used as an indication that the model needs to be updated. A difference below a threshold can indicate that the model does not need to be updated.

Attention is now drawn to FIG. 14.

As explained above, the model 120 has been generated for a fleet of specimens, by determining parameters (structural parameters, parameters informative of the material(s)) which minimize the difference between a simulated pixel intensity profile and a measured pixel intensity profile, at a given landing energy.

The method of FIG. 14 includes obtaining (operation 1400) the model generated at a given landing energy.

The method of FIG. 14 further includes testing the validity of the model at different landing energies, which differ from the given landing energy. This can include using (operation 1410) the model to generate a simulated pixel intensity profile of a specimen (such as a specimen of the fleet) at another landing energy, different from the given landing energy, and comparing the simulated pixel intensity profile with a measured pixel intensity profile at this other landing energy. This can be performed for a plurality of landing energies, different from the given landing energy.

The method of FIG. 14 further includes using (operation 1430) this comparison to determine whether the model needs to be updated. If the comparison indicates a match for different landing energies, this indicates that the model is valid for different landing energies. If the comparison indicates a mismatch for at least one landing energy, the method of FIG. 14 can further include updating the model. Update of the model can be performed by repeating operation 820, in order to fine-tune the estimate of the parameters informative of the material of the specimen.

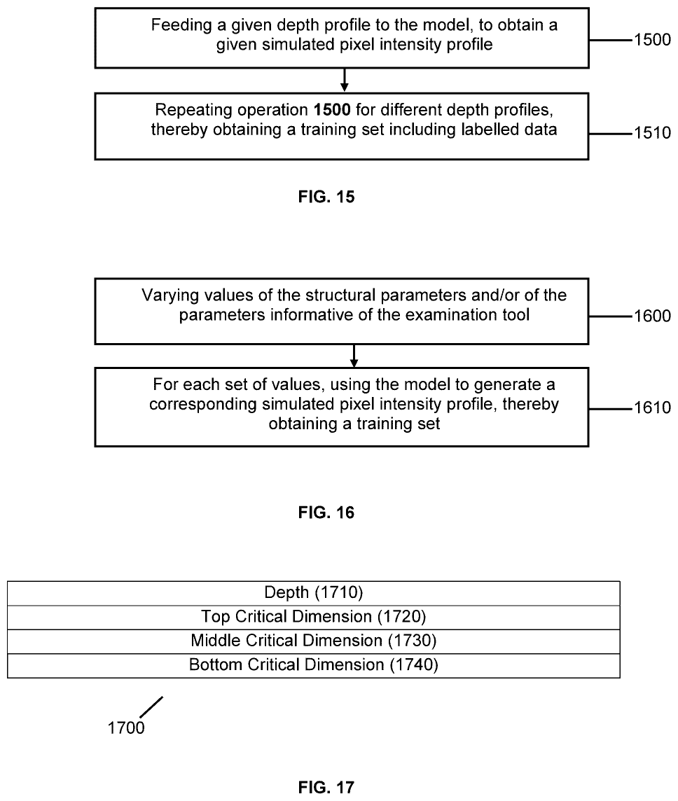

Attention is now drawn to FIG. 15, which depicts a method of generating a training set for training the machine learning model 112.

As mentioned above, a model has been generated for a fleet of specimens. The model is operative to simulate, based on structural parameters (depth, critical dimension, etc.) of a specimen, parameters informative of the materials of the specimen, and a landing energy of an examination tool, a simulated pixel intensity profile.

Generation of the training set can include (see operations 1500, 1510) feeding the model with different values of the depth and obtaining different simulated pixel intensity profiles. The material parameters can be kept as constant in the model, as estimated during generation of the model, in order to reflect the material parameters of the fleet of specimens.

This enables obtaining labelled data. Each labelled data includes a simulated pixel intensity profile, and a corresponding label including the corresponding depth profile.

The labelled data (including the depth profile, used as a label, and the corresponding simulated pixel intensity profile) can be used in a training set to train the machine learning model 112.

FIG. 16 describes another method of generating a training set.

In some examples, for a given depth profile, the value of one or more structural parameters (e.g., critical dimension of a trench, side wall angle, etc.) can be varied (operation 1600) and fed to the model, and the corresponding simulated pixel intensity value can be generated by the model (operation 1610). The corresponding data (including the depth profile, used as a label, and the corresponding simulated pixel intensity profile) can be used in a training set to train the machine learning model 112.

In some examples, for each value of a plurality of values of the landing energy, the corresponding simulated pixel intensity value can be generated by the model. The corresponding data (including the depth profile, used as a label, and the corresponding simulated pixel intensity profile) can be used in a training set to train the machine learning model.

These methods enable generating a large number of simulated pixel intensity profiles, for different configurations (different geometries, different landing energies, etc.) which are labelled with a corresponding depth profile. These configurations can be simulated, and it is not required to perform actual measurements at these different configurations.

In some examples, assume that an estimate of various structural parameters of a specimen has been obtained, as explained above. The specimen can be a reference specimen of the fleet of specimens.

FIG. 17 depicts a table 1700 which includes an estimate for various structural parameters of the specimen, including e.g., the depth 1710, the top critical dimension 1720, the middle critical dimension 1730, and the bottom critical dimension 1740 (this list is not limitative). Variations around these nominal values are performed, to generate different combinations of values. Note that the landing energy can be also varied. For each combination of values of the structural parameters of the specimen, and of the parameters of the examination tool, the model 120 generates a corresponding simulated pixel intensity profile. As a consequence, a large training set is obtained, which includes a simulated pixel intensity profile and a label corresponding to the depth profile.

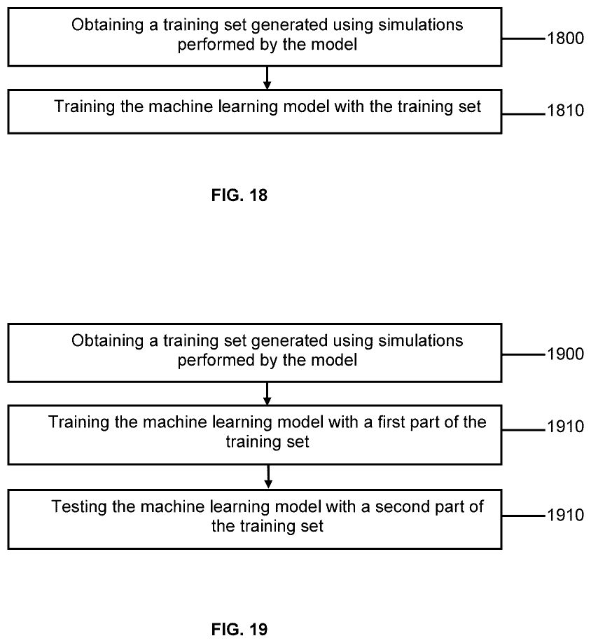

Attention is now drawn to FIG. 18, which depicts a method of training the machine learning model 112.

Once the training set has been generated (operation 1800), as explained above, the training set can be fed to the machine learning model 112 for its training. The training set includes a plurality of data, each including a simulated pixel intensity profile, and a label corresponding to the depth value (or depth profile). Training can rely on methods such as Backpropagation.

The machine learning model 112 is trained (operation 1810) to predict, based on a pixel intensity profile, the corresponding depth value (or depth profile). Since the training set has been generated using simulations, it covers a large variety of configurations (geometrical parameters, acquisition parameters, etc.) and enables a robust and accurate training of the machine learning model 112.

The trained machine learning model 112 is particularly adapted to specimens which are associated with material and structural parameters that are similar to the material and structural parameters of the specimens used to generate the model 120 and, in turn, the training set.

FIG. 19 depicts a method of testing the model. Assume that a training set has been obtained (operation 1900). The method of FIG. 19 includes using (operation 1910) a first part of the training set to train the machine learning model 112. The method of FIG. 19 further includes using (operation 1920), a second part of the training set, different from the first part of the training set, to test the validity of the model. This second part has not been used in the initial training phase of the model. In some examples, the first part corresponds to 80 percent of the training set, and the second part corresponds to 15-20 percent of the training set. These values are not limitative and different values can be used.

In the detailed description, numerous specific details have been set forth in order to provide a thorough understanding of the disclosure. However, it will be understood by those skilled in the art that the presently disclosed subject matter may be practiced without these specific details. In other instances, well-known methods, procedures, components, and circuits have not been described in detail so as not to obscure the presently disclosed subject matter.

Unless specifically stated otherwise, as apparent from the aforementioned discussions, it is appreciated that throughout the specification discussions utilizing terms such as “obtaining”, “applying”, “determining”, “performing”, “using”, “estimating”, “training”, “feeding”, or the like, refer to the action(s) and/or process(es) of a processing circuitry that manipulates and/or transforms data into other data, said data represented as physical, such as electronic, quantities and/or said data representing the physical objects.

The terms “computer” or “computer-based system” should be expansively construed to include any kind of hardware-based electronic device with a data processing circuitry (e.g., digital signal processor (DSP), a GPU, a TPU, a field programmable gate array (FPGA), an application specific integrated circuit (ASIC), microcontroller, microprocessor etc.), including, by way of non-limiting example, the computer-based system 103 of FIG. 1 and respective parts thereof disclosed in the present application. The data processing circuitry (designated also as processing circuitry) can comprise, for example, one or more processors operatively connected to computer memory, loaded with executable instructions for executing operations, as further described below. The data processing circuitry encompasses a single processor or multiple processors, which may be located in the same geographical zone, or may, at least partially, be located in different zones, and may be able to communicate together. The one or more processors can represent one or more general-purpose processing devices such as a microprocessor, a central processing unit, or the like. More particularly, a given processor may be one of: a complex instruction set computing (CISC) microprocessor, a reduced instruction set computing (RISC) microprocessor, a very long instruction word (VLIW) microprocessor, a processor implementing other instruction sets, or a processor implementing a combination of instruction sets. The one or more processors may also be one or more special-purpose processing devices such as an application specific integrated circuit (ASIC), a field programmable gate array (FPGA), a digital signal processor (DSP), a network processor, or the like. The one or more processors are configured to execute instructions for performing the operations and steps discussed herein.

The memories referred to herein can comprise one or more of the following: internal memory, such as, e.g., processor registers and cache, etc., main memory such as, e.g., read-only memory (ROM), flash memory, dynamic random access memory (DRAM) such as synchronous DRAM (SDRAM) or Rambus DRAM (RDRAM), etc.

The terms “non-transitory memory” and “non-transitory storage medium” used herein should be expansively construed to cover any volatile or non-volatile computer memory suitable to the presently disclosed subject matter. The terms should be taken to include a single medium or multiple media (e.g., a centralized or distributed database, and/or associated caches and servers) that store the one or more sets of instructions. The terms shall also be taken to include any medium that is capable of storing or encoding a set of instructions for execution by the computer and that cause the computer to perform any one or more of the methodologies of the present disclosure. The terms shall accordingly be taken to include, but not be limited to, a read only memory (“ROM”), random access memory (“RAM”), magnetic disk storage media, optical storage media, flash memory devices, etc.

It is to be noted that while the present disclosure refers to the processing circuitry 104 being configured to perform various functionalities and/or operations, the functionalities/operations can be performed by the one or more processors of the processing circuitry 104 in various ways. By way of example, the operations described hereinafter can be performed by a specific processor, or by a combination of processors. The operations described hereinafter can thus be performed by respective processors (or processor combinations) in the processing circuitry 104, while, optionally, at least some of these operations may be performed by the same processor. The present disclosure should not be limited to be construed as one single processor always performing all the operations.

The term “specimen” used in this specification should be expansively construed to cover any kind of wafer, masks, and other structures, combinations and/or parts thereof used for manufacturing semiconductor integrated circuits, magnetic heads, flat panel displays, and other semiconductor-fabricated articles.

The term “examination” used in this specification should be expansively construed to cover any kind of metrology-related operations as well as operations related to detection and/or classification of defects in a specimen during its fabrication. Examination is provided by using non-destructive examination tools during or after manufacture of the specimen to be examined. By way of non-limiting example, the examination process can include runtime scanning (in a single or in multiple scans), sampling, reviewing, measuring, classifying and/or other operations provided with regard to the specimen or parts thereof, using the same or different inspection tools. Likewise, examination can be provided prior to manufacture of the specimen to be examined, and can include, for example, generating an examination recipe(s) and/or other setup operations. It is noted that, unless specifically stated otherwise, the term “examination”, or its derivatives used in this specification, is not limited with respect to resolution or size of an inspection area. A variety of non-destructive examination tools includes, by way of non-limiting example, scanning electron microscopes, atomic force microscopes, optical inspection tools, etc.

By way of non-limiting example, run-time examination can employ a two-phase procedure, e.g., inspection of a specimen followed by review of sampled locations of potential defects. During the first phase, the surface of a specimen is inspected at high-speed and relatively low-resolution. In the first phase, a defect map is produced to show suspected locations on the specimen having high probability of a defect. During the second phase, at least some of the suspected locations are more thoroughly analyzed with relatively high resolution. In some cases, both phases can be implemented by the same inspection tool, and, in some other cases, these two phases are implemented by different inspection tools.

It is appreciated that, unless specifically stated otherwise, certain features of the presently disclosed subject matter, which are described in the context of separate embodiments, can also be provided in combination in a single embodiment. Conversely, various features of the presently disclosed subject matter, which are described in the context of a single embodiment, can also be provided separately, or in any suitable sub-combination. In the following detailed description, numerous specific details are set forth in order to provide a thorough understanding of the methods and apparatus.

In embodiments of the presently disclosed subject matter, fewer, more, and/or different stages than those shown in the methods of FIGS. 2, 4A, 7B, 8, 9, 12A, 13, 14, 15, 16, 18, and 19 may be executed. In embodiments of the presently disclosed subject matter, one or more stages illustrated in the methods of FIGS. 2, 4A, 7B, 8, 9, 12A, 13, 14, 15, 16, 18, and 19 may be executed in a different order, and/or one or more groups of stages may be executed simultaneously.

It is to be understood that the invention is not limited in its application to the details set forth in the description contained herein or illustrated in the drawings.

It will also be understood that the system according to the invention may be, at least partly, implemented on a suitably programmed computer. Likewise, the invention contemplates a computer program being readable by a computer for executing the method of the invention. The invention further contemplates a non-transitory computer-readable memory tangibly embodying a program of instructions executable by the computer for executing the method of the invention.

The invention is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the presently disclosed subject matter.

Those skilled in the art will readily appreciate that various modifications and changes can be applied to the embodiments of the invention as hereinbefore described without departing from its scope, defined in and by the appended claims.

What is claimed is:

1. A system comprising one or more processing circuitries configured to:
obtain data D_{pixel_intensity} informative of a pixel intensity profile of a given specimen, and
feed the data D_{pixel_intensity} to a machine learning model to determine, based on the data D_{pixel_intensity}, data informative of a depth of the given specimen,
wherein the machine learning model has been trained with a training set, wherein at least part of the training set has been generated based on a model operative to simulate, based on one or more parameters informative of a specimen, data informative of a pixel intensity profile of the specimen.

2. The system of claim 1, wherein the one or more parameters comprise:
one or more structural parameters of the specimen, and
one or more parameters informative of one or more materials of the specimen.

3. The system of claim 1, wherein generation of the training set comprises using the model to simulate, for each of a plurality of different values of at least one of:
one or more structural parameters of one or more specimens, or
one or more parameters informative of acquisition by an examination tool,
a simulated pixel intensity profile.

4. The system of claim 3, wherein the one or more structural parameters comprise at least one of: depth, critical dimension, thickness, or wall angle.

5. The system of claim 1, wherein the model has been generated by estimating one or more structural parameters of one or more specimens, and one or more parameters informative of one or more materials of the one or more specimens.

6. The system of claim 5, wherein at least one of (i) or (ii) is met:
(i) the one or more specimens and the given specimen have been manufactured using a same manufacturing process;
(ii) the one or more parameters, informative of the one or more materials of the one or more specimens and of the given specimen, match each other.

7. The system of claim 1, wherein generation of the model comprises determining one or more structural parameters of one or more specimens, for which a simulated pixel intensity profile generated by the model, based on said one or more structural parameters, matches a measured pixel intensity profile of the one or more specimens.

8. The system of claim 7, wherein the one or more structural parameters comprise at least one of: a depth of one or more elements of the one or more specimens, a critical dimension of the one or more elements of the one or more specimens, a top critical dimension of the one or more elements of the one or more specimens, a bottom critical dimension of the one or more elements of the one or more specimens, a middle critical dimension of the one or more elements of the one or more specimens, a wall angle of the one or more elements of the one or more specimens, parameters informative of wall bowing, parameters informative of one or more protrusions.

9. The system of claim 1, wherein generation of the model comprises determining one or more parameters informative of one or more materials of one or more specimens, for which a simulated pixel intensity profile generated by the model, based on said one or more parameters, matches a measured pixel intensity profile of the one or more specimens.

10. The system of claim 9, wherein the one or more parameters informative of one or more materials of the one or more specimens comprise at least one of: density, material composition, Fermi level, work function, or bandgap.

11. The system of claim 1, wherein at least one of (i) or (ii) is met:
(i) generation of the model comprises optimizing an estimate of one or more structural parameters of one or more specimens, until a simulated pixel intensity profile generated by the model, based on said estimate of said one or more structural parameters, matches a measured pixel intensity profile of the one or more specimens, according to an optimization criterion;
(ii) generation of the model comprises optimizing an estimate of one or more parameters informative of one or more materials of one or more specimens, until a simulated pixel intensity profile generated by the model, based on said estimate of said one or more parameters, matches a measured pixel intensity profile of the one or more specimens, according to an optimization criterion.

12. The system of claim 1, wherein the model is operative to simulate:
(i) a first simulation representative of interaction between irradiated electrons of a beam of an examination tool with the specimen;
(ii) a second simulation representative of collection and detection of escaped electrons from the specimen.

13. The system of claim 1, wherein generation of the model comprises repeating at least once a sequence comprising (1) and (2):
(1) estimating one or more parameters informative of one or more materials of one or more specimens;
(2) estimating one or more structural parameters of one or more specimens.

14. The system of claim 1, configured to:
obtain a measured pixel intensity profile of one or more specimens,
estimate one or more parameters informative of one or more materials of the one or more specimens, by minimizing a difference between:
a simulated pixel intensity profile of the one or more specimens, obtained based on the model and the estimate of the one or more parameters informative of the one or more materials of the specimen, and
a measured pixel intensity profile of the specimen,
and
estimate one or more structural parameters of the one or more specimens, by minimizing a difference between:
a simulated pixel intensity profile of the one or more specimens, obtained based on the model, and the estimate of the one or more structural parameters of the one or more specimens, and
the measured pixel intensity profile of the one or more specimens.

15. The system of claim 1, wherein generation of the model comprises:
generating a first model associated with a first estimate of one or more parameters informative of one or more materials of a first element of a specimen,
using the first model, one or more structural parameters of a second element, different from the first element, to generate a simulated pixel intensity profile of the second element, and
comparing the simulated pixel intensity profile of the second element with a measured pixel intensity profile of the second element.

16. The system of claim 1, wherein generation of the model includes:
generating a first model associated with a first estimate of one or more parameters informative of one or more materials of a given element of a specimen,
obtaining actual structural parameters of the given element of the specimen, based on cutting of said specimen, and
using the actual structural parameters and the first model to determine a simulated pixel intensity profile of the given element.

17. The system of claim 1, configured to obtain a landing energy, wherein a relationship between:
data informative of a dependency of a pixel intensity, or of an electron yield, of one or more specimens, on a depth of the one or more specimens, at said landing energy, and
data informative of a dependency of the pixel intensity, or of the electron yield, of the one or more specimens, on one or more other parameters informative of the one or more specimens, at said landing energy, meets a criterion,
wherein the data D_{pixel_intensity} have been obtained with said landing energy.

18. The system of claim 1, wherein the data informative of the pixel intensity profile of the given specimen comprises data informative of a ratio between:
data informative of a maximal value of a pixel intensity profile in a region of the given specimen, and
data informative of a minimal value of the pixel intensity profile in said region of the given specimen.

19. A method comprising, by one or more processing circuitries:
obtaining data D_{pixel_intensity} informative of a pixel intensity profile of a given specimen,
feeding the data D_{pixel_intensity} to a machine learning model to determine, based on the data D_{pixel_intensity}, data informative of a depth of the given specimen,
wherein the machine learning model has been trained with a training set, wherein at least part of the training set has been generated based on a model operative to predict, based on one or more parameters informative of a specimen, data informative of a pixel intensity profile of the specimen.

20. A non-transitory computer readable medium comprising instructions that, when executed by one or more computers, cause the one or more computers to perform:
obtaining data D_{pixel_intensity} informative of a pixel intensity profile of a given specimen,
feeding the data D_{pixel_intensity} to a machine learning model to determine, based on the data D_{pixel_intensity}, data informative of a depth of the given specimen,
wherein the machine learning model has been trained with a training set, wherein at least part of the training set has been generated based on a model operative to predict, based on one or more parameters informative of a specimen, data informative of a pixel intensity profile of the specimen.
